(19) United States
(12) Patent Application Publication
(10) Pub. No.: US 2012/0197841 A1
(43) Pub. Date: Aug. 2, 2012

(54) SYNCHRONIZING DATA TO MEDIA

(76) Inventors: Yotam LAUFER, Tei-Aviv (IL); Sefi Yosef Golan, Tel-Aviv (IL)

(21) Appl. No.: 13/019,756

(22) Filed: Feb. 2, 2011

(51) Int. Cl. G06F 17/30

(52) U.S. Cl. 707/618; 707/E17.005

(57) ABSTRACT

An apparatus for synchronizing data to a content item, the apparatus comprising: a data receiver, configured to receive the data and the content item, a data segment presenter, associated with the data receiver, configured to present a plurality of sequential segments of the received data and a graphical object associated with each respective one of the segments to a user, a content player, associated with the data receiver, configured to play at least a part of the content item to the user, and a time map definer, associated with the data segment presenter, operable by the user for defining a time mapping of the segments to the content item, by visually modifying a proportion among the objects simultaneously to the playing.

### FIELD AND BACKGROUND OF THE INVENTION

The present invention relates to media content and, more particularly, but not exclusively to synchronizing data to media content items.

The rise of streaming media (and particularly music and video) services and the decreasing importance of physical distribution is an inevitable change that the media industries have been facing, which has resulted from the internet revolution over the past few years.

Today, there emerge more and more new digital media consumption habits.

One consumption habit of special interest has involved the consumption of media content items presented with relevant data, such as a song presented with its original lyrics, a video clip presented with guitar tabs, etc.

For example, many video clips with textual subtitles are currently available on web sites such as You Tube.

Typically, the textual subtitles are embedded in the media content item, using professional editing equipment.

For example, U.S. Pat. No. 7,852,411, to Adolph et al., entitled “Method and apparatus for composition of subtitles”, filed on Nov. 3, 2003, describes an apparatus which utilizes a subtitling format. The subtitling format described by Adolph, encompasses elements of enhanced syntax and semantics, and the apparatus aims at providing subtitle animation capabilities.

### SUMMARY OF THE INVENTION

According to one aspect of the present invention, there is provided an apparatus for synchronizing data to a content item, the apparatus comprising: a data receiver, configured to receive the data and the content item, a data segment presenter, associated with the data receiver, configured to present a plurality of sequential segments of the received data and a graphical object associated with each respective one of the segments, to a user, a content player, associated with the data receiver, configured to play at least a part of the content item to the user, and a time map definer, associated with the data segment presenter, operable by the user for defining a time mapping of the segments to the content item, by visually modifying a proportion among the objects simultaneously to the playing.

According to a second aspect of the present invention, there is provided a computer implemented method for synchronizing data to a content item, the method comprising the steps of: receiving the data and the content item, presenting a plurality of sequential segments of the received data and a graphical object associated with each respective one of the segments to a user, playing at least a part of the content item to the user, and allowing the user to define a time mapping of the segments to the content item, by visually modifying a proportion among the objects simultaneously to the playing.

According to a third aspect of the present invention there is provided a computer readable medium storing computer executable instructions for performing steps of synchronizing data to a content item, the steps comprising: receiving the data and the content item, presenting a plurality of sequential segments of the received data and a graphical object associated with each respective one of the segments to a user, playing at least a part of the content item to the user, and allowing the user to define a time mapping of the segments to the content item, by visually modifying a proportion among the objects simultaneously to the playing.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a block diagram schematically illustrating an apparatus for synchronizing data to a content item, according to an exemplary embodiment of the present invention.

FIG. 2 is a flowchart schematically illustrating an exemplary method, for synchronizing data to a content item, according to an exemplary embodiment of the present invention.

FIG. 3 is a block diagram schematically illustrating a computer readable medium storing computer executable instructions for performing steps of synchronizing data to a content item, according to an exemplary embodiment of the present invention.

FIG. 4A is a first block diagram schematically illustrating a Graphical User Interface, for synchronizing data to a content item, according to an exemplary embodiment of the present invention.

FIG. 4B is a second block diagram schematically illustrating a Graphical User Interface, for synchronizing data to a content item, according to an exemplary embodiment of the present invention.

FIG. 4C is a third block diagram schematically illustrating a Graphical User Interface, for synchronizing data to a content item, according to an exemplary embodiment of the present invention.

FIG. 4D is a fourth block diagram schematically illustrating a Graphical User Interface, for synchronizing data to a content item, according to an exemplary embodiment of the present invention.

FIG. 4E is a fifth block diagram schematically illustrating a Graphical User Interface, for synchronizing data to a content item, according to an exemplary embodiment of the present invention.

### DESCRIPTION OF THE PREFERRED EMBODIMENTS

The present embodiments comprise a method, a computer readable medium, and an apparatus for synchronizing data to a content item.

In an exemplary computer implemented method, according to an exemplary embodiment of the present invention, there is received a content item such as an audio file or a video clip, say a video clip downloaded from a web site such as YouTube.

Further received is relevant data, such as lyrics of a song played in the video clip, musical annotations (say chords, tablature, notes, etc.) of the song, etc.

Optionally, the data is downloaded by a computer user from a web site, such as www.lyrics.com or www.ultimate-guitar.com.

Optionally, the data originates from a chord book scanned into the computer's memory, from a tablature file, etc.

Then, the content item, or at least a part of the item, is played to a user, and the user is presented with sequential segments of the data, say with the song's lyrics broken into separate lines arranged in a vertical list, with the song's music notes broken into phrases arranged vertically or horizontally, etc.

Each segment is presented associated with a graphical object, say a text box the segment (say line of lyrics) is presented in, an elongated bar presented next to the segment (say phrase), etc.

Then, the user defines a time mapping of the segments to the content item, by visually modifying a proportion among the objects, say by adjusting the lengths of the elongated bars or the text boxes, simultaneously to the playing of the content item to the user.

Optionally, in a preliminary step, the user initializes the time mapping of the data segments to the content item simultaneously to the playing of the content item (or a part of the item). The user initializes the time mapping, by skipping among the sequential data segments (say the lines of lyrics as presented in the text boxes).

In one example, the user skips among the segments, using one of the computer's keyboard keys, such as a tab key or an enter key, as described in further detail hereinbelow.

Then, the user is allowed to define the time mapping, by visually modifying the proportion among the objects simultaneously to the playing of the content item.

In one example, the user is repetitively played two or more sequential parts of the content item, say two sequential parts of the video clip.

During the repetitive playing of the parts, the user is allowed to fine-tune the time mapping simultaneously to the repetitive playing.

In the example, each of the two (or more) data segments (say adjacent lines of the song lyrics) is presented in a text box. Each text box's length is proportional to a time length of a part of the content item, to which the data segment is mapped.

Throughout the repetitive playing of the two (or more) parts, the user is allowed to adjust the lengths of the two (or more) boxes.

Consequently, the mapping of the two (or more) data segments to the content item is accordingly fine-tuned, as described in further detail hereinbelow.

Optionally, with an exemplary method of the present invention, a user may map segments to a content item on a purely comparative basis, in a graphical way, without directly measuring time units or tempo for different parts of the content item.

The principles and operation of a method, an apparatus and a computer readable medium, according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

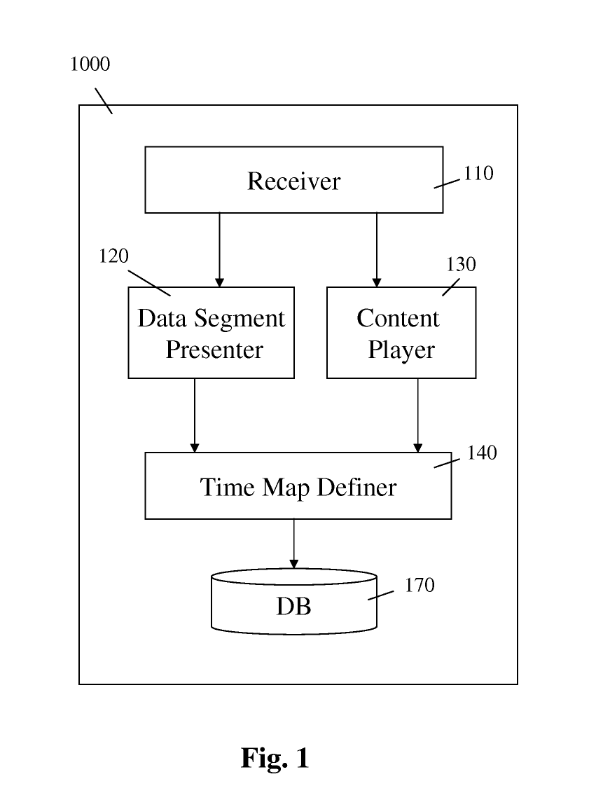

Reference is now made to FIG. 1, which is a block diagram schematically illustrating an apparatus for synchronizing data to a content item, according to an exemplary embodiment of the present invention.

An exemplary apparatus 1000, for synchronizing data to a content item, may be implemented as a computer program installed on a user's computer (say a desktop computer, a laptop computer, a tablet computer, a cellular phone, etc).

The apparatus 1000 may also be implemented as a server application in remote communication with a dedicated client program installed on the user's computer or as a part of a server application, as known in the art.

The apparatus 1000 may also be implemented in a Software-as-a-Service (SaaS) mode, as known in the art.

In one exemplary SaaS model, the apparatus 1000 is implemented on a server computer remote from the user and the user communicates with apparatus 1000, using a standard internet browser (say Microsoft™ Internet Explorer, Google™ Chrome, etc.), without a dedicated client program.

The apparatus 1000 includes a data receiver 110.

The data receiver 110 receives a content item, and data for synchronization with the content item.

The content item may include audio-visual media (say a video clip downloaded from a web site such as YouTube), audio media (say an MP3 file), etc., as known in the art.

The data may include, but is not limited to relevant data such lyrics of a song played in the video clip, musical annotations (say chords, tablature, notes, etc.) of the song, etc.

Optionally, the data is downloaded by a user who operates the data receiver 110, from a website such as www.lyrics.com or www.ultimate-guitar.com.

Optionally, the data originates from a chord book scanned into the computer's memory, from a tablature file, etc., as known in the art.

The apparatus 1000 further includes a data segment presenter 120, in communication with the data receiver 110.

The data segment presenter 120 presents two or more sequential segments of the received data (say lines of lyrics or chord phases), and a graphical object associated with each respective one of the segments, to a user.

The graphical object may include, but is not limited to a text box the segment (say line of lyrics) is presented in, an elongated bar presented next to the segment (say a phrase), etc.

The apparatus 1000 further includes a content player 130, in communication with the data receiver 110.

The content player 130 plays the content item or a part of the content item, to the user.

The content player 130 may be implemented using a Windows™ Media Player, a Winamp® Media Player, or using any another conventional media player, as known in the art.

Apparatus 1000 further includes a time map definer 140, in communication with the data segment presenter 120.

The user operates the time map definer 140, for defining a time mapping of the segments to the content item, by visually modifying a proportion among the objects presented to the user. The user modifies the proportion simultaneously to the playing of the content item (or a part of the content item) to the user.

In one example, the content item is a video clip of a song, played to the user.

As the content player 130 plays the video clip (or at least a part of the clip) to the user, the data segment presenter 120 presents the lyrics of the song performed in the video clip to the user.

In the example, the lyrics are automatically broken into separate lines (i.e. segments), say using a data breaker, as described in further detail hereinbelow.

The lines are presented to the user in a vertical list, as described in further detail hereinbelow.

In the example, each segment (i.e. line of the lyrics) is presented associated with a graphical object, say a text box the segment is presented in, an elongated bar presented next to the segment, etc.

Then, using the time map definer 140, the user defines a time mapping of the segments to the content item, by visually modifying a proportion among the graphical objects.

In the example, the user defines the time mapping, by adjusting the lengths of one or more of the elongated bars or the text boxes, simultaneously to the playing of the video clip, as described in further detail hereinbelow.

That is to say that the order of the segments and the modifiable proportion among the segments, serve as a basis for mapping the segments to the content item (or the part of the item) played to the user while the user modifies the proportion, as described in further detail hereinbelow.

Optionally, the time map definer 140 is further operable by the user, for initializing the time mapping of the presented segments to the content item.

The user may operate the time map definer 140, for initializing the time mapping, by skipping among the presented segments (say the graphical objects) simultaneously to the playing, and prior to the modifying of the proportion among the segments, as described in further detail hereinbelow.

Optionally, the user skips among the lines, by hitting one of the computer's keyboard keys (say the keyboard's tab key).

In the example, a time in which the user hits the key, to skip between a first data segment and an adjacent, second segment of the data, is used as a timestamp separating between two parts of the content item. The time is counted from when the content item's playing starts, and the timestamp is relative to the playing start time.

Consequently, the first data segment (say a first line of the lyrics) is mapped to a first part of the content item (say a first part of the video clip) which ends at the time marked by the timestamp (i.e. at the time in which the user skips to the second data segment, relative to when the playing starts).

The skipping does not stop the playing of the content to the user.

Similarly, by skipping from the second data segment to a third data segment, the user maps the second segment to a second part of the content item (say a second part of the video clip). The second parts ends at the time (relative to the time in which the content item playing starts) when the user skips between the second and third data segments.

As the playing of the content item continues, until the end of the content item's playing (or of the item part's playing), the user skips among the sequential data segments.

For example, the user may skip among bars presented next to the lines (i.e. data segments), or among text boxes in which the lines are presented, thus defining an initial time mapping between the data segments and the content item.

Optionally, the proportion among of the bars, text boxes, or other graphical objects associated with the data segments (say lines) is automatically adjusted, in light of the initial time mapping.

For example, a text box of a data segment (say line) mapped to a longer (in terms of duration) part of the content item (say the video clip) becomes longer than a text box of a line mapped to a shorter part of the item, as described in further detail hereinbelow.

Then, the user may operate the time map definer 140, for defining the time mapping, by visually modifying the proportion among the graphical objects simultaneously to the playing of the content item, say by changing the lengths of the bars or text boxes.

As the length of one of the graphical objects changes, the length of the content item's part that the segment associated with the object is mapped to, also changes, as described in further detail hereinbelow.

Optionally, the content player 130 repetitively plays two or more sequential parts of the content item to the user, and the time map definer 140 is further operable by the user, for fine-tuning the time mapping in relation to the repetitively played parts, simultaneously to the repetitive playing.

The user may operate the time map definer 140, by visually modifying a proportion among the objects simultaneously to the repetitive playing, as described in further detail hereinbelow.

In one example, the content player 130 repetitively plays two sequential parts of a video clip, to the user.

During the repetitive playing of the two parts, the user is allowed to fine-tune the time mapping simultaneously to the repetitive playing, using the time map definer 140.

In the example, each of the two data segments (say adjacent lyrics lines of a song performed in the video clip) is presented in a text box. Each text box's length is proportional to a time length of a part of the content item, to which the data segment is mapped.

Throughout the repetitive playing of the two parts, the user is allowed to adjust the lengths of the two boxes.

Consequently, the mapping of the two data segments to the content item is accordingly fine-tuned, as described in further detail hereinbelow.

Optionally, the time map definer 140 stores one or more data records, which represent the data mapping defined by the user, in a dedicated database 170, say on a Microsoft™ SQL Server database, as described in further detail hereinbelow.

Optionally, the apparatus 1000 further includes a synchronizer, in communication with the time map definer 140.

The synchronizer synchronizes the content item and the data, using the time mapping as defined by the user and represented by the records stored in the database 170, and thereby generates a data synchronized content item.

In one example, the data synchronized content item is a video clip on which the lines of lyrics are presented as subtitles, generated by the synchronizer.

Optionally, the apparatus 1000 further includes a data breaker, in communication with the data receiver 110.

The data breaker breaks the data into the sequential data segments.

Optionally, the data breaker breaks the data into the sequential segment in an automatic manner.

For example, the data breaker may break the data into the data segments automatically, by identifying patterns such as punctuation marks, tablature boxes, etc., in the data. Then, the data breaker uses the patterns, to parse the data, and thereby divides the parsed data into the data segments, as described in further detail hereinbelow.

Optionally, the data breaker breaks the data into the data segments semi-automatically, in a process in which the user provides feedbacks, say by correcting the data's division which is based on the parsing of the data.

Optionally, the data breaker breaks the data into the sequential segment manually (through operation by the user).

For example, the data breaker may be operated by the user, for breaking the data into the data segments in a manual process in which the user edits the data and divides the data into the segments.

Optionally, the data segment presenter 120 further allows the user to select one of the segments presented to the user, for down breaking.

Then, the data segment presenter 120 presents two or more sub-segments of the segment selected by the user, to the user. Simultaneously to the presentation of the sub-segments, the content player 130 plays a part of the content item, the selected data segment is mapped to, to the user.

Optionally, the user operates the time map definer 140, for modifying the time mapping simultaneously to the playing of the part to which the selected data segment is mapped, by skipping among the sub-segments, as described in further detail hereinbelow.

Optionally, the user operates the time map definer 140, for modifying the time mapping, by changing a proportion between the sub-segments (say by changing one of the sub-segment's length), as described in further detail hereinbelow.

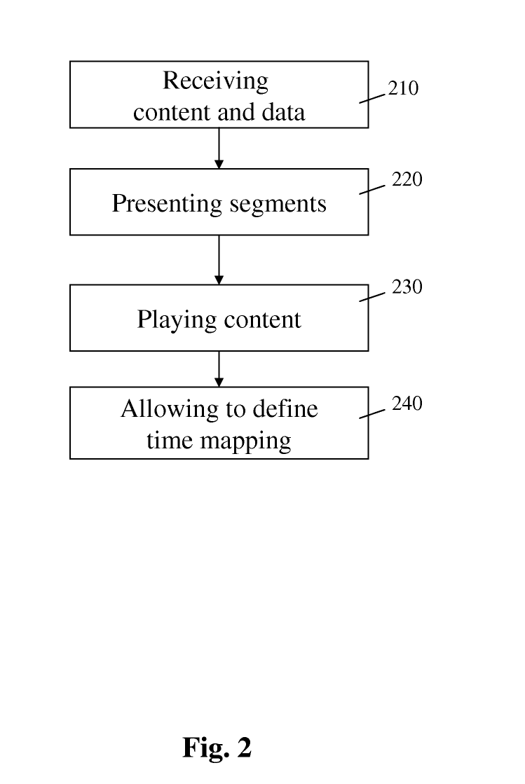

Reference is now made to FIG. 2, which is a flowchart schematically illustrating an exemplary method, for synchronizing data to a content item, according to an exemplary embodiment of the present invention.

An exemplary method, according to an exemplary embodiment of the present invention, may be implemented on apparatus 1000, as described in further detail hereinabove.

The apparatus 1000 may be implemented as a computer program installed on a user's computer (say a desktop computer, a laptop computer, a tablet computer, a cellular phone, etc), as described in further detail hereinabove. The apparatus 1000 may also be implemented as a server application in remote communication with a dedicated client program installed on the user's computer, or as a part thereof, as known in the art.

The apparatus 1000 may also be implemented in a Software-as-a-Service (SaaS) mode, as known in the art.

In one exemplary SaaS model, the apparatus 1000 is implemented on a server remote from the user and the user communicates with apparatus 1000, using a standard internet browser (say Microsoft™ Internet Explorer, Google™ Chrome, etc.), without a dedicated client program.

In the method, there are received 210 a content item and data for synchronization with the content item, say using the data receiver 110, as described in further detail hereinabove.

The content item may include audio-visual media (say a video clip downloaded by a user, from a web site such as YouTube), audio media (say an MP3 file), etc., as known in the art.

The data may include, but is not limited to relevant data such lyrics of a song played in the video clip, musical annotations (say chords, tablature, notes, etc.) of the song, etc.

Optionally, the data is received 210 from a web site such as www.lyrics.com or www.ultimate-guitar.com.

Optionally, the data is read from a chord book scanned into the computer's memory, from a tablature file, etc.

In another step of the exemplary method, there are presented 220 two or more sequential segments of the received 210 data, and a graphical object associated with each respective one of the segments, to a user, say using the data segment presenter 120, as described in further detail hereinabove.

The graphical object may include, but is not limited to a text box the segment (say line of lyrics) is presented in, an elongated bar presented next to the segment (say a phrase), etc.

The segments are presented 220 to the user simultaneously to playing 230 of the content item or a part of the content item, to the user (say by the content player 130), as described in further detail hereinabove.

During the playing 230 of the content item (or the part thereof), the user is allowed 240 to define a time mapping of the segments to the content item, by visually modifying a proportion among the objects presented 220 to the user.

The user modifies the proportion simultaneously to the playing 230 of the content item (or the part of the content item), for defining the time mapping, say using the time map definer 140, as described in further detail hereinabove.

In one example, the content item is a video clip of a song performed by Madonna, played to the user.

As the content player 130 plays 230 the video clip (or at least a part of the clip) to the user, the data segment presenter 120 presents 220 the lyrics of the song performed in the video clip to the user.

In the example, the lyrics are automatically broken into separate lines (i.e. segments) say using the data breaker, as described in further detail hereinabove.

The lines are presented 220 to the user in a vertical list, as described in further detail hereinbelow.

Each segment is presented 220 associated with a graphical object, say a text box the segment (say a line of the lyrics) is presented in, an elongated bar presented 220 next to the segment, etc.

Then, using the time map definer 140, the user is allowed 240 to define a time mapping of the segments to the content item, by visually modifying a proportion among the objects.

For example, the user may define the time mapping, by adjusting the lengths of the elongated bars or the text boxes, simultaneously to the playing 230 of the Madonna video clip, as described in further detail hereinbelow.

That is to say that the order of the segments and the modifiable proportion among the segments, serve as a basis for mapping the segments to the content item (or the part of the item) played 230 to the user while the user modifies the proportion, as described in further detail hereinbelow.

Optionally, the exemplary method further includes a preliminary step in which the user is allowed to initialize the time mapping of the presented 220 segments to the content item.

The user initializes the time mapping, using the time map definer 140, by skipping among the presented 220 segments (say the graphical objects) simultaneously to the playing 230, but prior to the modifying step 240 in which the user defines the time mapping.

Optionally, the user skips among the segments (say lines of lyrics), by hitting one of the computer's keyboard keys (say the tab key), as described in further detail hereinabove.

In the example, a time in which the user hits the key, to skip between a first data segment and an adjacent, second segment of the data, is used as a timestamp separating between two parts of the content item. The time is counted from when the content item's playing starts, and the timestamp is relative to the playing start time.

Consequently, the first data segment (say a first line of the lyrics) is mapped to a first part of the content item (say a first part of the video clip) which ends at the time marked by the timestamp (i.e. at the time in which the user skips to the second data segment, relative to when the playing starts).

The skipping does not stop the playing of the content to the user.

Similarly, by skipping from the second data segment to a third data segment, the user maps the second segment to a second part of the content item (say a second part of the video clip). The second part starts when the first part ends, and ends at the time (relative to the time in which the content item playing starts) when the user skips between the second and third data segments.

As the playing of the content item continues, until the end of the content item's playing (or of the item part's playing), the user skips among the sequential data segments.

For example, the user may skip among bars presented next to the lines (i.e. data segments), or among text boxes in which the lines are presented 220, thus defining an initial time mapping between the data segments and the content item.

Optionally, the proportion among of the bars, text boxes, or other graphical objects associated with the data segments (say lines) is automatically adjusted, in light of the initial time mapping. For example, a text box of a data segment (say line) mapped to a longer (in terms of duration) part of the content item (say the video clip) becomes longer than a text box of a line mapped to a shorter part of the item, as described in further detail hereinbelow.

Then, the user may operate the time map definer 140, for defining 240 the time mapping, by visually modifying the proportion among the objects simultaneously to the playing 230 of the content item, say by changing the lengths of the bars or text boxes.

As the length of an object changes, the length of the content item's part that the segment associated with the object is mapped to, also changes, as described in further detail hereinbelow.

Optionally, the exemplary method further includes repetitively playing two or more sequential parts of the content item, to the user. Then, the user may fine-tune the time mapping in relation to the repetitively played parts, simultaneously to the repetitive playing, say using the time map definer 140, as described in further detail hereinabove.

In one example, the content player 130 repetitively plays two sequential parts of the video clip, to the user.

During the repetitive playing of the two parts, the user is allowed to fine-tune the time mapping simultaneously to the repetitive playing, using the time map definer 140.

In the example, each of the two data segments (say adjacent lyrics lines of a song performed in the video clip) is presented in a text box. Each text box's length is proportional to a time length of a part of the content item, to which the data segment is mapped.

Throughout the repetitive playing of the two parts, the user is allowed to adjust the lengths of the two text boxes.

Consequently, the mapping of the two data segments to the content item is accordingly fine-tuned, as described in further detail hereinbelow.

Optionally, the method further include a step of storing one or more data records, which represent the data mapping defined by the user, in a dedicated database 170, as described in further detail hereinabove.

Optionally, the method further includes a step of synchronizing of the content item and the data, using the time mapping, as defined by the user.

Optionally, the synchronizing step is carried by the synchronizer, using the data records stored in the dedicated database 170, as described in further detail hereinabove.

Consequently, there may be generated a data synchronized content item, say a video clip on which the lines of lyrics are presented as subtitles.

Optionally, the method further includes a step in which the received 210 data is broken into the sequential data segments, say using the data breaker, as described in further detail hereinabove.

Optionally, the breaking of the data into the data segments is carried out automatically, say by identifying patterns such as punctuation marks, tablature boxes, etc., in the data. Then, the patterns are used to parse the data, and thereby to divide the data into the data segments.

Optionally, the breaking of the data into the segments is a semi-automatic process in which the user provides feedbacks, say by correcting the data's division based on the parsing of the data.

Optionally, the breaking of the data into the segments is a manual process in which the user edits the data and divides the data into the segments.

Optionally, the method further includes allowing the user to select one of the segments presented to the user, for down breaking.

Then, the user is presented two or more sub-segments of the segment selected by the user.

Simultaneously to the presentation of the sub-segments, the user is played a part of the content item, to which the selected data segment is mapped.

Optionally, the user operates the time map definer 140, for modifying the time mapping simultaneously to the playing of the part, to which the selected data segment is mapped, by skipping among the sub-segments, similarly to the skipping among the segments, as described in further detail hereinabove.

Optionally, the user operates the time map definer 140, for modifying the time mapping, by changing a proportion between the sub-segments (say by changing one of the sub-segment's length), similarly to the modifying of the proportion among the graphical objects, as described in further detail hereinabove.

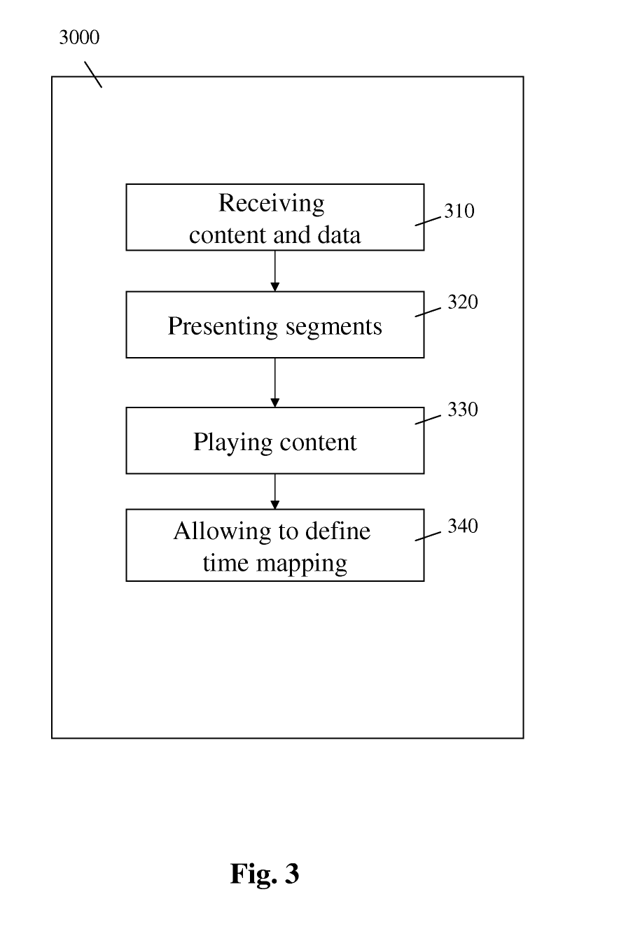

Reference is now made to FIG. 3, which is a block diagram schematically illustrating a computer readable medium storing computer executable instructions for performing steps of synchronizing data to a content item, according to an exemplary embodiment of the present invention.

According to an exemplary embodiment of the present invention, there is provided a computer readable medium 3000, such as a CD-ROM, a USB-Memory, a Portable Hard Disk, a diskette, etc.

The computer readable medium 3000 stores computer executable instructions, for performing steps of synchronizing data to a content item, according to an exemplary embodiment of the present invention.

The computer executable instructions include a step of receiving 310 a content item and data for synchronization with the content item, as described in further detail hereinabove.

The content item may include audio-visual media (say a video clip downloaded from a web site such as YouTube), audio media (say an MP3 file), etc., as known in the art.

The data may include, but is not limited to relevant data such lyrics of a song played in the video clip, musical annotations (say chords, tablature, notes, etc.) of the song, etc.

Optionally, the data is received 310 from a web site such as www.lyrics.com or www.ultimate-guitar.com.

Optionally, the data is read from a chord book scanned into the computer's memory, from a tablature file, etc.

The instructions further include a step of presenting 320 two or more sequential segments (say lines of lyrics, phrases of chords, etc.) of the received 310 data, and a graphical object associated with each respective one of the segments, to a user, as described in further detail hereinabove.

The graphical object may include, but is not limited to a text box the segment (say line of lyrics) is presented in, an elongated bar presented next to the segment (say a phrase), etc.

The segments are presented 320 to the user simultaneously to playing 330 of the content item or a part of the content item, to the user (say by the content player 130), as described in further detail hereinabove.

The executable instructions further include a step in which, during the playing 330 of the content item (or the part thereof), the user is allowed 340 to define a time mapping of the segments to the content item, by visually modifying a proportion among the objects presented 320 to the user.

The user modifies the proportion simultaneously to the playing 330 of the content item (or the part of the content item), for defining the time mapping, as described in further detail hereinabove.

In one example, the content item is a video clip of a song performed by Madonna, played to the user.

The user is played 330 the video clip (or at least a part of the clip) and presented 320 the lyrics of the song performed in the video clip.

In the example, the lyrics are automatically broken into separate lines (i.e. segments), as described in further detail hereinabove.

The lines are presented 320 to the user in a vertical list, as described in further detail hereinbelow.

Each segment is presented 320 associated with a graphical object, say a text box the segment (say a line of the lyrics) is presented in, an elongated bar presented 320 next to the segment, etc.

Then, the user is allowed 340 to define a time mapping of the segments to the content item, by visually modifying a proportion among the objects.

For example, the user may adjust the lengths of the elongated bars or the text boxes, simultaneously to the playing 330 of the Madonna video clip, as described in further detail hereinbelow.

That is to say that the order of the segments (say lines of lyrics) and the modifiable proportion among the segments, serve as a basis for mapping the segments to the content item (or the part of the item) played 330 to the user while the user modifies the proportion, as described in further detail hereinbelow.

Optionally, the instructions further include a preliminary step in which the user is allowed to initialize the time mapping of the presented segments to the content item.

The user initializes the time mapping, by skipping among the presented 320 segments (say by moving from one graphical object to another) simultaneously to the playing 330 and prior to the modifying step 340 in which the user defines the time mapping.

Optionally, the user skips among the segments (say lines of lyrics), by hitting one of the computer's keyboard keys (say the tab key), as described in further detail hereinabove.

In the example, a time in which the user hits the key, to skip between a first data segment and an adjacent, second segment of the data, is used as a timestamp separating between two parts of the content item. The time is counted from when the content item's playing starts, and the timestamp is relative to the playing start time.

Consequently, the first data segment (say a first line of the lyrics) is mapped to a first part of the content item (say a first part of the video clip) which ends at the time marked by the timestamp (i.e. at the time in which the user skips to the second data segment, relative to when the playing starts).

The skipping does not stop the playing of the content to the user.

Similarly, by skipping from the second data segment to a third data segment, the user maps the second segment to a second part of the content item (say a second part of the video clip). The second part starts when the first part ends, and ends at the time (relative to the time in which the content item playing starts) when the user skips between the second and third data segments.

As the playing of the content item continues, until the end of the content item's playing (or of the item part's playing), the user skips among the sequential data segments.

For example, the user may skip among bars presented next to the lines (i.e. data segments), or among text boxes in which the lines are presented 320, thus defining an initial time mapping between the data segments and the content item.

Optionally, the proportion among of the bars, text boxes, or other graphical objects associated with the data segments (say lines) is automatically adjusted, in light of the initial time mapping. For example, a text box of a data segment (say line) mapped to a longer (in terms of duration) part of the content item (say the video clip) becomes longer than a text box of a line mapped to a shorter part of the item.

Then, the user may define 340 the time mapping, by visually modifying the proportion among the objects simultaneously to the playing 330 of the content item, say by changing the lengths of the bars or text boxes, as described in further detail hereinabove.

As the length of an object changes, the length of the content item's part that the segment associated with the object is mapped to, also changes, as described in further detail hereinbelow.

Optionally, the executable instructions further include a step of repetitively playing two or more sequential parts of the content item to the user. Then, the user may fine-tune the time mapping in relation to the repetitively played parts, simultaneously to the repetitive playing, as described in further detail hereinabove.

In one example, the user is repetitively played two sequential parts of the video clip.

During the repetitive playing of the two parts, the user is allowed to fine-tune the time mapping simultaneously to the repetitive playing, as described in further detail hereinabove.

In the example, each of the two data segments (say adjacent lines lyrics of a song performed in the video clip) is presented in a text box. Each text box's length is proportional to a time length of a part of the content item, to which the data segment is mapped.

Throughout the repetitive playing of the two parts, the user is allowed to adjust the lengths of the two boxes.

Consequently, the time mapping of the two data segments to the content item is accordingly fine-tuned, as described in further detail hereinabove.

Optionally, the instructions further include a step of synchronizing of the content item and the data, using the time mapping, as defined by the user, say using the synchronizer, as described in further detail hereinabove. Consequently, there may be generated a data synchronized content item, say a video clip on which the lines of lyrics are presented as subtitles.

Optionally, instructions further include a step in which the received 310 data is broken into the sequential data segments, as described in further detail hereinabove.

Optionally, the breaking of the data into the data segments is carried out automatically, say by identifying patterns such as punctuation marks, tablature boxes, etc., in the data. Then, the patterns are used to parse the data, and thereby to divide the received 310 data into the data segments.

Optionally, the breaking of the data into the segments is a semi-automatic process in which the user provides feedbacks, say by correcting the data's division based on the parsing of the data.

Optionally, the breaking of the data into the segments is a manual process in which the user edits the data, and divides the data into the segments.

Optionally, the instructions further include a step of allowing the user to select one of the segments presented to the user, for down breaking.

Then, the user is presented two or more sub-segments of the segment selected by the user.

Simultaneously to the presentation of the sub-segments, the user is played a part of the content item, to which the selected data segment is mapped. The user may modify the time mapping simultaneously to the playing of the part to which the selected data segment is mapped. For example, the user may modify the time mapping, by skipping among the sub-segments, as described in further detail hereinbelow.

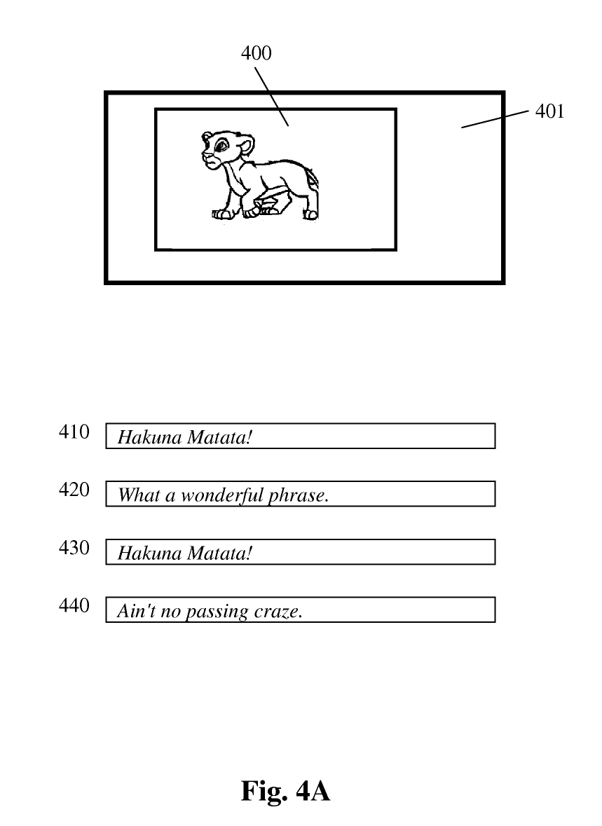

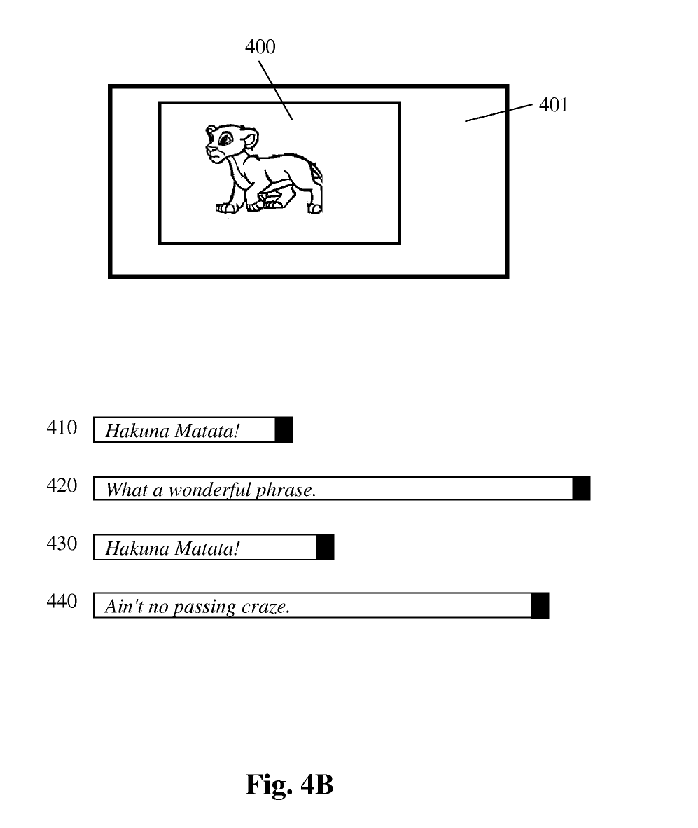

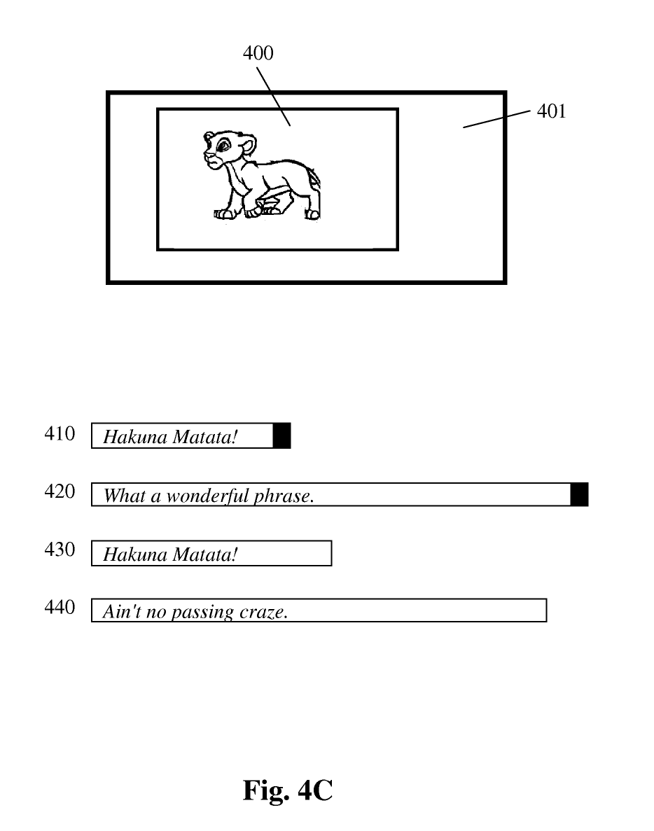

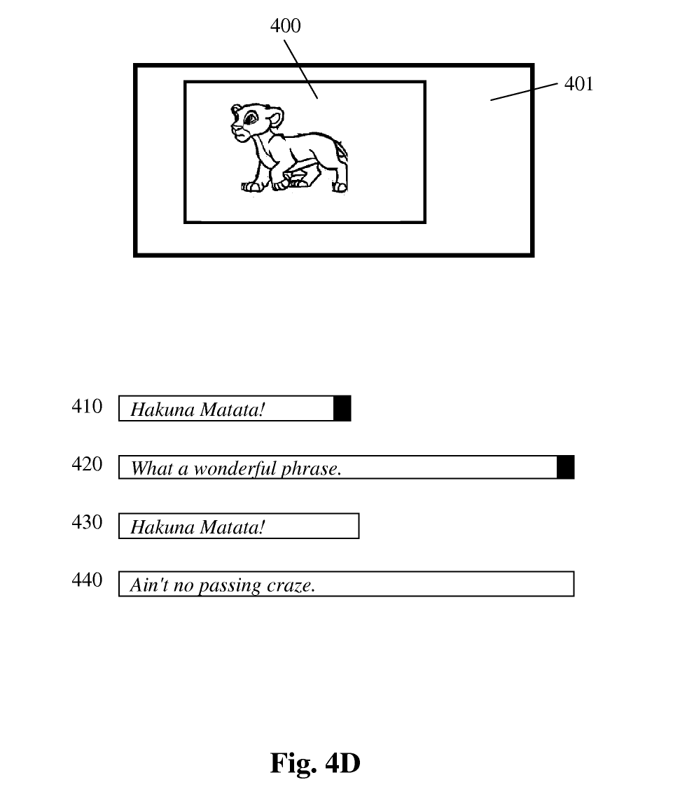

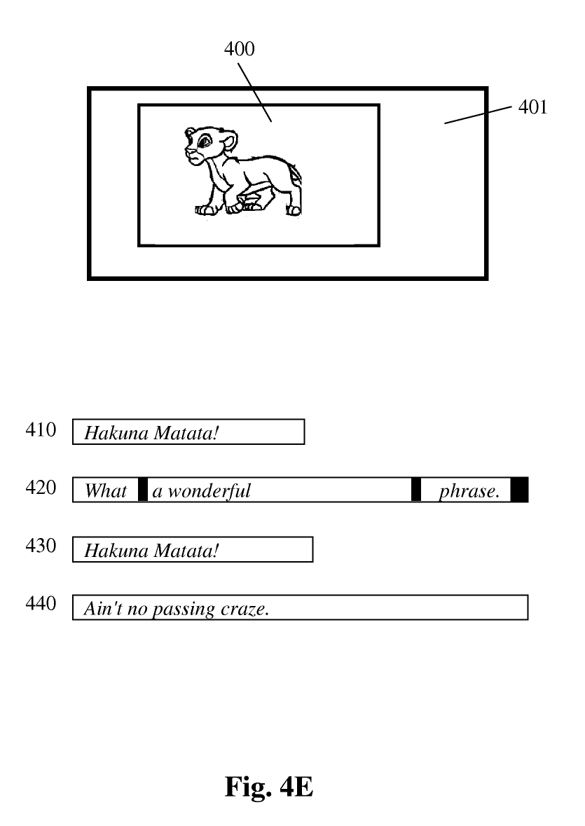

Reference is now made to FIG. 4A, which is a first block diagram schematically illustrating a Graphical User Interface, for synchronizing data to a content item, according to an exemplary embodiment of the present invention.

In one example, the content item is a video clip of the popular Hakuna Matata song, as performed in Walt Disney's The Lion King™ animated feature film.

In the example, the content player 130 plays a part of the clip 400 to the user, on a media player 401, such as Windows™ Media Player, a Winamp® Media Player, etc., to a user.

In the example, the song's lyrics are automatically broken into separate lines (i.e. data segments) say using the data breaker, as described in further detail hereinabove.

The lines 410-440 are presented to the user in a vertical list. Each line is presented in an elongated text box.

The user initializes a time mapping of the presented lines 410-440 of lyrics, to the video clip 400.

The user initializes the time mapping, using the time map definer 140, by skipping among the presented lines 410-440 (i.e. among the text boxes) simultaneously to the playing of the video clip 400.

Optionally, the user skips among the segments (i.e. lines of lyrics 410-440), by hitting one of the computer's keyboard keys (say the tab key), as described in further detail hereinabove.

In the example, a time in which the user hits the key, to skip between a first data line 410 and an adjacent, second line 420 of the lyrics, is used as a timestamp separating between two parts of the video clip 400. The time is counted from when the video clip's 400 playing starts, and the timestamp is relative to the playing start time.

Consequently, the first line 410 is mapped to a first part of the video clip 400, which ends at the time marked by the timestamp (i.e. at the time in which the user skips to the second line 420, relative to when the playing starts).

The skipping does not stop the playing of the video clip 400 to the user.

Similarly, by skipping from the second line 420 to a third data line 430, the user maps the second line 420 to a second part of the video clip. The second part starts when the first part ends, and ends at the time (relative to the time in which the content item playing starts) when the user skips between the second 420 and third 430 lines.

As the playing of the video clip 400 continues, until the end of the clip's 400 playing, the user skips among the sequential data segments (i.e. among the lines 410-440), thus initializing the time mapping.

Reference is now made to FIG. 4B, which is a second block diagram schematically illustrating a Graphical User Interface, for synchronizing data to a content item, according to an exemplary embodiment of the present invention.

In the example, the proportion among of text boxes in which the lines 410-440 are presented is automatically adjusted, in light of the time mapping as initialized.

For example, a text box of a data segment (i.e. line) 420 mapped to a longer (in terms of duration) part of the video clip 400, becomes longer than a text box of a line 410 mapped to a shorter part of the video clip 400.

After the initial mapping, the user uses the time map definer 140, to define a time mapping of the lines of lyrics, to the video clip 400, by visually modifying a proportion among the text boxes in which the lines 410-440 are presented.

In the example, the user defines the time mapping, by adjusting the lengths of the elongated text boxes, simultaneously to the playing of the video clip 400.

As the length of a text box changes, the length of the video clip's 400 part that the line presented in the text box is mapped to, also changes, as described in further detail hereinabove.

The order of the segments and the modifiable proportion among the segments, serve as a basis for mapping the lines 410-440 to the video clip 400 played 230 to the user while the user modifies the proportion, as described in further detail hereinabove.

Reference is now made to FIG. 4C, which is a third block diagram schematically illustrating a Graphical User Interface, for synchronizing data to a content item, according to an exemplary embodiment of the present invention.

Optionally, the user is repetitively played two sequential parts of the video clip 400.

Then, the user fine-tunes the time mapping in relation to the repetitively played parts, simultaneously to the repetitive playing, by adjusting a proportion between the two lines 410-420 mapped to the repetitively played parts.

In the example, each of the two lines is presented in a text box. Each text box's length is proportional to a time length of a part of the video clip 400, to which the line presented in the text box, is mapped.

Reference is now made to FIG. 4D, which is a fourth block diagram schematically illustrating a Graphical User Interface, for synchronizing data to a content item, according to an exemplary embodiment of the present invention.

Throughout the repetitive playing of the two parts, the user is allowed to adjust the lengths of the two boxes of lines 410-420.

Consequently, the mapping of the two lines 410-420 to the content item of the example (i.e. the video clip 400) is accordingly fine-tuned.

Reference is now made to FIG. 4E, which is a fifth block diagram schematically illustrating a Graphical User Interface, for synchronizing data to a content item, according to an exemplary embodiment of the present invention.

Optionally, the user may further select one 420 of the lines 410-440 presented to the user, for down breaking.

Then, the user is presented three sub-segments of the line 420 selected by the user (i.e. the strings ‘What’, ‘a wonderful’ and ‘phrase’).

Simultaneously to the presentation of the sub-segments, the user is played a part of the video clip 400, to which the selected line 420 is mapped.

The user modifies the time mapping simultaneously to the playing of the part to which the selected line 420 is mapped.

Optionally, the user modifies the time mapping, by skipping among the sub-segments, say using a computer keyboard key (say the tab key), similarly to the preliminary step in which the user initializes the time mapping, as described in further detail hereinabove, and discussed.

Optionally, for modifying the time mapping, the user adjusts the proportion between the sub-segments, say by graphically changing the length of one or more of the segments, similarly to the fine-tuning of the time mapping, as described in further detail hereinabove.

The graphical interface of the exemplary methods illustrated hereinabove, allows the user to graphically compare the length of the parts to which the data segments (say the music phrases) are mapped.

Once the user maps even a single one of the segments to the content item, the user only needs to compare the length of one segment (say phrase) to another.

Optionally, with the exemplary method of the present invention, the user may map the segments to the content item (say music clip) on a purely comparative basis, in a graphical way, without directly measuring time units or tempo for different parts of the content item.

In some examples, the content item consists of western music.

Western music is usually based on a steady tempo and on repetitive music phrases. Consequently, if one deciphers the length of one phrase it is usually very easy to accurately determine the length of the following phrases.

It is expected that during the life of this patent many relevant devices and systems will be developed and the scope of the terms herein, particularly of the terms “Computer”, “Video”, “Clip”, “Content item”, “Media player”, “Internet”, “Internet browser”, “MP3”, “Website”, “Chords”, “Tablature”, “Tabs”, “File”, and “Chord book”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An apparatus for synchronizing data to a content item, the apparatus comprising:
a data receiver, configured to receive the data and the content item;
a data segment presenter, associated with said data receiver, configured to present a plurality of sequential segments of the received data, and a graphical object associated with each respective one of the segments to a user;
a content player, associated with said data receiver, configured to play at least a part of the content item to the user; and
a time map definer, associated with said data segment presenter, operable by the user for defining a time mapping of the segments to the content item, by visually modifying a proportion among the objects simultaneously to said playing.

2. The apparatus of claim 1, wherein the time map definer is further operable by the user, for initializing the time mapping of the presented segments to the content item, by skipping among the presented segments simultaneously to said playing and prior to said modifying.

3. The apparatus of claim 1, wherein said content player is further configured to repetitively play at least two sequential parts of the content item to the user, and said time map definer is further operable by the user, for fine-tuning the time mapping in relation to the repetitively played parts, simultaneously to said repetitive playing, by visually modifying a proportion among the objects simultaneously to said playing.

4. The apparatus of claim 1, further comprising a synchronizer, configured to synchronize the content item and the data, using the defined time mapping, thereby to generate a data synchronized content item.

5. The apparatus of claim 1, wherein said data segment presenter is further configured to present at least two sub-segments of a selected one of the data segments to the user, said content player is further configured to play a part of the content item, the selected data segment is mapped to, to the user, and said time mapping definer is operable by the user, for modifying the time mapping simultaneously to the playing of the part, the selected data segment is mapped to, by skipping among the sub-segments.

6. The apparatus of claim 1, further comprising a data breaker, configured to break the data into the sequential data segments.

7. The apparatus of claim 1, wherein the data comprises lyrics.

8. The apparatus of claim 1, wherein the data comprises music chords.

9. The apparatus of claim 1, wherein the data comprises tablature.

10. A computer implemented method for synchronizing data to a content item, the method comprising the steps of:
receiving the data and the content item;
presenting a plurality of sequential segments of the received data and a graphical object associated with each respective one of the segments to a user;
playing at least a part of the content item to the user; and
allowing the user to define a time mapping of the segments to the content item, by visually modifying a proportion among the objects simultaneously to said playing.

11. The method of claim 10, further comprising allowing the user to initialize the time mapping of the presented segments to the content item, by skipping among the presented segments simultaneously to said playing and prior to said modifying.

12. The method of claim 10, further comprising repetitively playing at least two sequential parts of the content item to the user, and allowing the user to fine-tune the time mapping in relation to the repetitively played parts, simultaneously to said repetitive playing, by visually modifying a proportion among the objects simultaneously to said playing.

13. The method of claim 10, further comprising synchronizing the content item and the data, using the defined time mapping, thereby generating a data synchronized content item.

14. The method of claim 10, further comprising presenting at least two sub-segments of a selected one of the data segments to the user, playing a part of the content item, the selected data segment is mapped to, to the user, and allowing the user to modify the time mapping simultaneously to the playing of the part, the selected data segment is mapped to, by skipping among the sub-segments.

15. The method of claim 10, further comprising breaking the data into the sequential data segments.

16. The apparatus of claim 10, wherein the data comprises lyrics.

17. The apparatus of claim 10, wherein the data comprises music chords.

18. The apparatus of claim 10, wherein the data comprises tablature.

19. A computer readable medium storing computer executable instructions for performing steps of synchronizing data to a content item, the steps comprising:
receiving the data and the content item;
presenting a plurality of sequential segments of the received data and a graphical object associated with each respective one of the segments to a user;
playing at least a part of the content item to the user; and
allowing the user to define a time mapping of the segments to the content item, by visually modifying a proportion among the objects simultaneously to said playing.
